(19) United States
(12) Patent Application Publication
(10) Pub. No.: US 2023/0256338 A1
(43) Pub. Date: Aug. 17, 2023

(54) METHOD FOR CONTROLLING CALL OBJECT IN VIRTUAL SCENE, APPARATUS FOR CONTROLLING CALL OBJECT IN VIRTUAL SCENE, DEVICE, STORAGE MEDIUM, AND PROGRAM PRODUCT

(71) Applicant: TENCENT TECHNOLOGY (SHENZHEN) COMPANY LIMITED, Shenzhen (CN)

(72) Inventor: Fenlin CAI, Shenzhen (CN)

(73) Assignee: TENCENT TECHNOLOGY (SHENZHEN) COMPANY LIMITED, Shenzhen (CN)

(21) Appl. No.: 18/303,851

(22) Filed: Apr. 20, 2023

Related U.S. Application Data
(63) Continuation of application No. PCT/CN2022/090972, filed on May 5, 2022.

(30) Foreign Application Priority Data
May 31, 2021 (CN) 202110602499.3

(51) Int. Cl. A63F 13/56; G06T 19/20; A63F 13/58; G06V 10/74

(52) U.S. Cl. CPC A63F 13/56; A63F 13/58; G06T 19/20; G06V 10/761; G06T 2219/2004

(57) ABSTRACT

A method for controlling a call object in a virtual scene, an apparatus for controlling a call object in a virtual scene, a device, a computer-readable storage medium, and a computer program product. The method includes: presenting a target virtual object and the call object in a first form in the virtual scene, controlling the call object to transform from the first form to a second form based on the target virtual object being in an interactive preparation state, the interactive preparation state being a state for interacting with another virtual object in the virtual scene, and controlling the call object in the second form to be in an interactive auxiliary state to assist the target virtual object to interact with the other virtual objects

### CROSS-REFERENCE TO RELATED APPLICATION(S)

This application is a continuation application of International Application No. PCT/CN2022/090972 filed on May 5, 2022 which claims priority to Chinese Patent Application No. 202110602499.3, filed with the National Intellectual Property Administration, PRC on May 31, 2021, the disclosures of which are incorporated by reference herein in their entireties.

### FIELD

The disclosure relates to the human-computer interaction technology, in particular to a method for controlling a call object in a virtual scene, an apparatus for controlling a call object in a virtual scene, a device, a computer-readable storage medium, and a computer program product.

### BACKGROUND

In most current virtual scene applications, users mostly control a single virtual object through a terminal to interact with other virtual objects in a virtual scene. However, the skills and abilities of the single virtual object are relatively limited. In order to achieve a certain interactive purpose, users need to control the single virtual object through the terminal to perform multiple interactive operations, so that the human-computer interaction efficiency is low.

### SUMMARY

Embodiments of the disclosure provide a method for controlling a call object in a virtual scene, an apparatus for controlling a call object in a virtual scene, a device, a computer-readable storage medium, and a computer program product.

Some embodiments provide a method for controlling a call object in a virtual scene, including:
presenting a target virtual object and the call object in a first form in the virtual scene; and
controlling the call object to transform from the first form to a second form based on the target virtual object being in an interactive preparation state, the interactive preparation state being a state for interacting with another virtual object in the virtual scene, and
controlling the call object in the second form to assist the target virtual object to interact with the other virtual objects.

Some embodiments provide a method for controlling a call object in a virtual scene, including:
presenting a target virtual object holding a shooting prop and a call object in a character form in a virtual shooting scene;
controlling the target virtual object to aim at a target position by the shooting prop in the virtual shooting scene, and presenting a corresponding sight pattern in the target position; and
controlling the call object to move to the target position, and transforming the character form to a shield state in the target position to assist the target virtual object to interact with the other virtual objects in response to a transformation instruction triggered based on the sight pattern.

Some embodiments provide an apparatus for controlling a call object in a virtual scene, including: at least one memory configured to store program code; and at least one processor configured to read the program code and operated as instructed by the program code, the program code including
object presentation code configured to cause the at least one processor to present a target virtual object and the call object in a first form in the virtual scene; and
state control code configured to cause the at least one processor to control the call object to transform from the first form to a second form based on the target virtual object being in an interactive preparation state, the interactive preparation state being a state for interacting with another virtual object in the virtual scene, and control the call object in the second form to assist the target virtual object to interact with the other virtual objects.

Some embodiments provide an apparatus for controlling a call object in a virtual scene, including: at least one memory configured to store program code; and at least one processor configured to read the program code and operated as instructed by the program code, the program code including:
a first presentation module, configured to present a target virtual object holding a shooting prop and a call object in a character form in a virtual shooting scene;
an aiming control module, configured to control the target virtual object to aim at a target position by the shooting prop in the virtual shooting scene, and present a corresponding sight pattern in the target position; and
a state transformation module, configured to control the call object to move to the target position, and transform the character form to a shield state in the target position to assist the target virtual object to interact with the other virtual objects in response to a transformation instruction triggered based on the sight pattern.

Some embodiments provide an electronic device, including:
a memory, configured to store executable instructions; and
a processor, configured to implement the method for controlling a call object in a virtual scene provided in the embodiments of the disclosure when executing the executable instructions stored in the memory.

Some embodiments provide a computer-readable storage medium storing executable instructions, when executed by a processor, configured to implement the method for controlling a call object in a virtual scene provided in the embodiments of the disclosure.

Some embodiments provide a computer program product including computer programs or instructions, when executed by a processor, configured to implement the method for controlling a call object in a virtual scene provided in the embodiments of the disclosure.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is a schematic architectural diagram of a system 100 for controlling a call object in a virtual scene according to some embodiments.

FIG. 2 is a schematic structural diagram of an electronic device 500 according to some embodiments.

FIG. 3A is a schematic flowchart of a method for controlling a call object in a virtual scene according to some embodiments.

FIG. 3B is a schematic flowchart of a method for controlling a call object in a virtual scene according to some embodiments.

FIG. 4 is a schematic diagram of following of a call object according to some embodiments.

FIG. 5 is a schematic diagram of state transformation of a call object according to some embodiments.

FIG. 6 is a schematic diagram of state transformation of a call object according to some embodiments.

FIG. 7 is a schematic diagram of call conditions of a call object according to some embodiments.

FIG. 8 is a schematic diagram of a call method according to some embodiments.

FIG. 9 is a schematic diagram of a following method of a call object according to some embodiments.

FIG. 10 is a schematic diagram of determination of a moving position according to some embodiments.

FIG. 11 is a schematic diagram of a state transformation method of a call object according to some embodiments.

FIG. 12 is a schematic diagram of state transformation of a call object according to some embodiments.

FIG. 13 is a schematic diagram of an action effect of a call object according to some embodiments.

FIG. 14A is a schematic diagram of a picture observed through a call object according to some embodiments

FIG. 14B is a schematic diagram of a picture observed through a call object according to some embodiments.

FIG. 15 is a schematic diagram of state transformation of a call object according to some embodiments.

FIG. 16 is a schematic structural diagram of an apparatus for controlling a call object in a virtual scene according to some embodiments.

### DETAILED DESCRIPTION

In the technical solution provided by the embodiments of the disclosure, provided is a target virtual object and a call object in a first form in a virtual scene are presented; and the form of the call object is controlled to be transformed from the first form to a second form in a case that the target virtual object is in an interactive preparation state for interacting with other virtual objects in the virtual scene, and the call object in the second form is controlled to be in an interactive auxiliary state to assist the target virtual object to interact with the other virtual objects. In this way, when the target virtual object is in an interactive preparation state, the form of the call object may be automatically controlled to be transformed from the first form to the second form, and the call object is controlled to be in an interactive auxiliary state. Without any user operation, the call object may be automatically controlled to assist the target virtual object to interact with the other virtual objects. By means of skills of the call object, skills of the target virtual object are able to improve, thereby greatly reducing the number of interactive operations performed by the target virtual object controlled by a user operation terminal for achieving a certain interactive purpose, increasing the human-computer interaction efficiency, and saving the computing resource consumption.

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following description, the term “some embodiments” describes subsets of all possible embodiments, but it may be understood that “some embodiments” may be the same subset or different subsets of all the possible embodiments, and can be combined with each other without conflict.

In the following description, the involved terms “first”, “second”, and the like are merely intended to distinguish similar objects, but do not represent a specific order of objects. It may be understood that the “first”, “second”, and the like may be interchanged in a specific order or a sequential order if allowed, so that the embodiments of the disclosure described herein are able to implement in an order other than those illustrated or described herein.

Unless otherwise defined, meanings of all technical and scientific terms used in this specification are the same as those usually understood by a person skilled in the art to which the disclosure belongs. Terms used herein are merely intended to describe objectives of the embodiments of the disclosure, but are not intended to limit the disclosure.

Before the embodiments of the disclosure are further described in detail, a description is made on and terms in the embodiments of the disclosure, and the and terms in the embodiments of the disclosure are applicable to the following explanations.

1) “Client” is an application running in a terminal to provide various services, such as a video playback client and a game client.

2) “In response to” is used for indicating a condition or a state on which the performed operation depends. When the dependent condition or state is met, one or more performed operations may be real-time or may have a set delay. Unless otherwise specified, there is no restriction on the performing order of multiple performed operations.

3) “Virtual scene” is a virtual scene displayed (or provided) when an application runs on a terminal. The virtual scene may be a simulated environment of the real world, a semi-simulated and semi-virtual environment, or a pure virtual environment. The virtual scene may be any of a two-dimensional virtual scene, a 2.5-dimensional virtual scene or a three-dimensional virtual scene. The dimension of the virtual scene is not limited in the embodiments of the disclosure.

For example, when the virtual scene is a three-dimensional virtual space, the three-dimensional virtual space may be an open space, and the virtual scene may be used for simulating a real environment in reality. For example, the virtual scene may include sky, land, sea, and the like, and the land may include desert, cities and other environmental elements. Certainly, the virtual scene may further include virtual items, such as buildings, carriers, and weapons and other props required by virtual objects in the virtual scene to arm themselves or fight with other virtual objects. The virtual scene may further be used for simulating the real environment under different weather conditions, such as sunny, rainy, foggy or dark weather. Users may control virtual objects to move in the virtual scene.

4) “Virtual objects” are images of various people and things that can interact in the virtual scene, or movable objects in the virtual scene. The movable objects may be virtual characters, virtual animals, cartoon characters, and the like, such as characters, animals, plants, oil drums, walls, stones, and the like, displayed in the virtual scene. The virtual object may be a virtual image for representing a user in the virtual scene. The virtual scene may include a plurality of virtual objects, and each virtual object has a shape and a volume in the virtual scene, and occupies some space in the virtual scene.

In some embodiments, the virtual object may be a user role that is controlled by operations on a client, artificial intelligence (AI) set in virtual scene battle through training, or a non-player character (NPC) set in virtual scene interaction. In some embodiments, the virtual object may be a virtual character that interacts in an adversarial way in a virtual scene. In some embodiments, the number of virtual objects participating in interaction in the virtual scene may be preset or dynamically determined according to the number of clients participating in interaction.

Using a shooting game as an example, in the virtual scene, a user may control a virtual object to fall freely, glide, or fall after a parachute is opened in the sky, or to run, jump, creep, or bend forward in the land, or control the virtual object to swim, float, or dive in the sea. Certainly, the user may further control the virtual object to ride in a virtual carrier to move in the virtual scene. For example, the virtual carrier may be a virtual vehicle, a virtual aircraft, a virtual yacht, or the like. The foregoing scenes are used as an example only herein, which is not specifically limited in the embodiments of the disclosure. The user may further control the virtual object to interact with other virtual objects through virtual props in an adversarial way. For example, the virtual props may be grenades, cluster grenades, sticky grenades and other throwing virtual props, or may be machine guns, pistols, rifles and other shooting virtual props. The control type of the call object in the virtual scene is not specifically limited in the disclosure.

5) “Call objects” or “summon objects” are images of various people and things that may assist a virtual object to interact with other virtual objects in a virtual scene. The images may be virtual characters, virtual animals, cartoon characters, virtual props, virtual carriers, and the like.

6) “Scene data” represents various features of objects in a virtual scene during interaction, such as positions of objects in the virtual scene. Certainly, different types of features may be included according to types of virtual scenes. For example, in a virtual scene of a game, the scene data may include the waiting time for various functions configured in the virtual scene (depending on the number of times of using the same function in a specific time), and may further represent attribute values of various states of game characters, such as a hit point (energy value, also known as red volume) and a magic point (also known as blue volume).

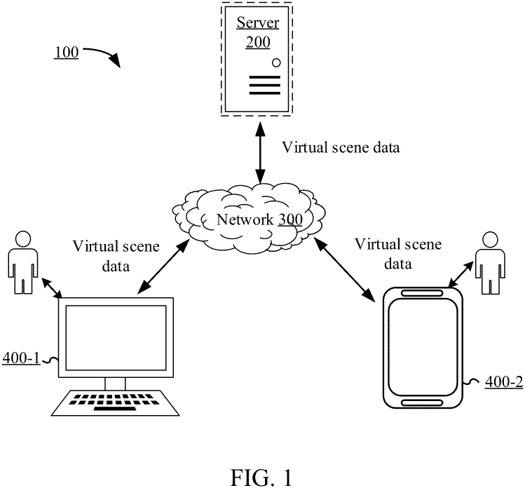

FIG. 1 is a schematic architectural diagram of a system 100 for controlling a call object in a virtual scene according to some embodiments. In order to support an example application, terminals (for example, a terminal 400-1 and a terminal 400-2) are connected to a server 200 through a network 300. The network 300 may be a wide area network, a local area network, or a combination of the wide area network and the local area network, and uses wireless or wired links for data transmission.

Terminals may be smart phones, tablet personal computers, laptop computers and various types of user terminals, and may further be desk computers, game consoles, televisions or any combination of two or more of these data processing devices. The server 200 may be a separately configured server supporting various services, may be configured as a server cluster, or may be a cloud server.

In practical applications, an application that supports a virtual scene is installed in and runs on a terminal. The application may be any of first-person shooting games (FPS), third-person shooting games, multiplayer online battle arena games (MOBA), two dimension (2D) game applications, three dimension (3D) game applications, virtual reality applications, 3D map programs or multiplayer gunfight survival games. The application may further be a stand-alone application, such as a stand-alone 3D game program.

The virtual scene involved in the embodiments of the present disclosure may be used for simulating a 3D virtual space. The 3D virtual space may be an open space. The virtual scene may be used for simulating a real environment in reality. For example, the virtual scene may include sky, land, sea, and the like, and the land may include desert, cities and other environmental elements. Certainly, the virtual scene may further include virtual items, such as buildings, tables, carriers, and weapons and other props required by virtual objects in the virtual scene to arm themselves or fight with other virtual objects. The virtual scene may further be used for simulating the real environment under different weather conditions, such as sunny, rainy, foggy or dark weather. The virtual object may be a virtual image for representing a user in the virtual scene. The virtual image may be in any form, such as simulated characters and simulated animals, which is not limited in the present disclosure. In practical implementations, a user may use a terminal to control a virtual object to carry out activities in the virtual scene. The activities include but are not limited to: at least one of adjusting body posture, creeping, running, riding, jumping, driving, picking, shooting, attacking, throwing, cutting and stabbing.

Using a video game scene as an example scene, a user may perform an operation on the terminal in advance. After the terminal detects the operation of the user, a game configuration file of a video game may be downloaded, and the game configuration file may include an application, interface display data, virtual scene data, or the like of the video game, so that the user (or player) may invoke the game configuration file while logging in to the video game on the terminal to render and display an interface of the video game. The user may perform a touch operation on the terminal. After detecting the touch operation, the terminal may send an obtaining request of game data corresponding to the touch operation to a server, the server determines the game data corresponding to the touch operation based on the obtaining request and returns the game data to the terminal, and the terminal renders and displays the game data. The game data may include virtual scene data, behavioral data of a virtual object in the virtual scene, and the like.

In practical applications, a terminal presents a target virtual object and a call object in a first form in a virtual scene; and controls the form of the call object to be transformed from the first form to a second form in a case that the target virtual object is in an interactive preparation state for interacting with other virtual objects in the virtual scene, and controls the call object in the second form to be in an interactive auxiliary state to assist the target virtual object to interact with the other virtual objects.

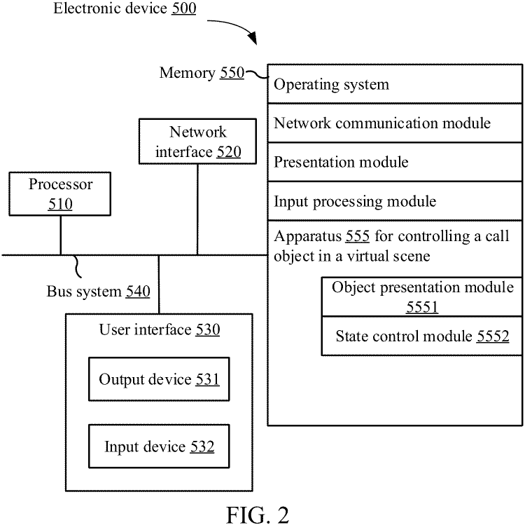

FIG. 2 is a schematic structural diagram of an electronic device 500 according to some embodiments. In practical applications, the electronic device 500 may be a terminal 400-1, a terminal 400-2 or a server 200 in FIG. 1. Taking the electronic device which is a terminal 400-1 or a terminal 400-2 shown in FIG. 1 as an example, the electronic device for implementing a method for controlling a call object in a virtual scene in the embodiments of the disclosure is described. The electronic device 500 shown in FIG. 2 includes: at least one processor 510, a memory 550, at least one network interface 520, and a user interface 530. All components in the electronic device 500 are coupled together through a bus system 540. It may be understood that, the bus system 540 is configured to implement connection and communication between the components. In addition to a data bus, the bus system 540 further includes a power bus, a control bus, and a state signal bus. But, for ease of clear description, all types of buses in FIG. 2 are marked as the bus system 540.

The processor 510 may be an integrated circuit chip with a signal processing ability, such as a general processor, a digital signal processor (DSP), another programmable logic device, discrete gate or transistor logic device, or discrete hardware assembly, or the like. The general processor may be a microprocessor or any conventional processor.

The user interface 530 includes one or more output apparatus 531 that enable the presentation of media contents, including one or more speakers and/or one or more visual display screens. The user interface 530 further includes one or more input apparatus 532, including user interface components that facilitate user input, such as keyboards, mouse devices, microphones, touch display screens, cameras, other input buttons and controls.

The memory 550 may be removable, non-removable, or a combination thereof. Example hardware devices include solid-state memories, hard disk drives, optical disk drives, and the like. The memory 550 may include one or more storage devices away from the processor 510 in a physical position.

The memory 550 includes a volatile memory or a non-volatile memory, or may include both a volatile memory and a non-volatile memory. The non-volatile memory may be a read only memory (ROM), and the volatile memory may be a random access memory (RAM). The memory 550 described in the embodiment of the disclosure is intended to include any suitable type of memory.

In some embodiments, an apparatus for controlling a call object in a virtual scene may be performed by using software. FIG. 2 shows an apparatus 555 for controlling a call object in a virtual scene stored in the memory 550, which may be software in the form of programs and plug-ins, including the following software modules: an object presentation module 5551 and a state control module 5552. These modules are logical modules, and thus may be randomly combined or further divided according to implemented functions. Functions of each module will be described below.

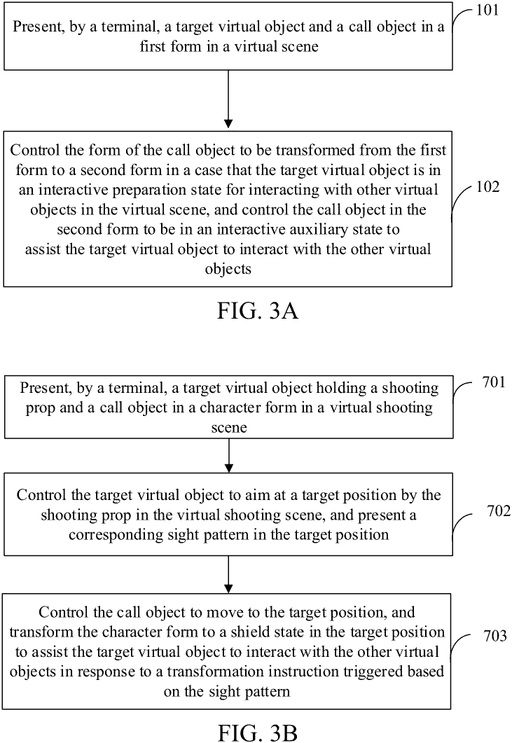

The following describes a method for controlling a call object in a virtual scene according to some embodiments. In practical implementations, the method may be implemented by a server or a terminal alone, or implemented by a server and a terminal in cooperation. FIG. 3A is a schematic flowchart of a method for controlling a call object in a virtual scene according to some embodiments. A description is made with reference to operations shown in FIG. 3A.

Operation 101: Present, by a terminal, a target virtual object and a call object in a first form in a virtual scene.

Here, a client supporting virtual scenes is installed on the terminal. When a user opens the client on the terminal and the terminal runs the client, the terminal sends an obtaining request of scene data of a virtual scene to a server, the server obtains the scene data of the virtual scene indicated by the scene identifier based on the scene identifier carried by the obtaining request, and returns the obtained scene data to the terminal, and the terminal renders a picture based on the received scene data, so as to present a picture of the virtual scene obtained by observing the virtual scene from the perspective of a target virtual object, and present the target virtual object and a call object in a first form in the picture of the virtual scene. Here, the picture of the virtual scene is obtained by observing the virtual scene from the perspective of the first-person object, or obtained by observing the virtual scene from the perspective of the third-person object. The picture of the virtual scene includes virtual objects and an object interaction environment for interactive operations, such as a target virtual object controlled by the current user and a call object associated with the target virtual object.

The target virtual object is a virtual object in the virtual scene corresponding to the current login account. In the virtual scene, the user may control the target virtual object to interact with other virtual objects (different from the virtual object in the virtual scene corresponding to the current login account) based on an interface of the virtual scene, such as control the target virtual object to hold virtual shooting props (such as virtual sniper guns, virtual submachine guns and virtual scatter guns) to shoot other virtual objects. Call objects are images of various people and things for assisting a target virtual object to interact with other virtual objects in a virtual scene. The images may be virtual characters, virtual animals, cartoon characters, virtual props, virtual carriers, and the like.

In some embodiments, before presenting a call object in a first form, the terminal may call, or summon, the call object in the first form by: controlling a target virtual object to pick up the virtual item (or virtual chip) in a case that a virtual item for calling the call object exists in a virtual scene; obtaining an energy value of the target virtual object; and calling the call object based on the virtual item in a case that the energy value of the target virtual object reaches an energy threshold.

Here, the virtual item for calling, or summoning, the call object may be configured in the virtual scene in advance, and the virtual item may exist in a specific position in the virtual scene, that is, a user may assemble the virtual item by a pickup operation. In practical applications, the virtual item may also be picked up before the user enters the virtual scene or in the virtual scene, obtained through rewards, or purchased. The virtual item may exist in a scene setting interface, that is, the user may assemble the virtual item based on a setting operation in the scene setting interface.

After controlling the target virtual object to assemble the virtual item, the terminal obtains attribute values of the target virtual object, such as a hit point and an energy value of the target virtual object; then, whether the attribute value of the target virtual object meets the call condition corresponding to the call object is judged; for example, when the call condition corresponding to the call object is that the attribute value of the virtual object needs to reach 500 points, whether the call condition corresponding to the call object is met may be determined by judging whether the energy value of the target virtual object exceeds 500 points; and when it is determined that the call condition corresponding to the call object is met based on the attribute value (that is, the energy value of the target virtual object exceeds 500 points), the call object corresponding to the target virtual object is called based on the assembled virtual item.

In practical applications, the call conditions corresponding to the call object may further include: whether to interact with a target virtual monster (such as an elite monster in a virtual state (the hit point is less than a preset threshold). When it is determined that the call condition corresponding to the call object is met (that is, interacting with the target virtual monster), the call object corresponding to the target virtual object is called based on the assembled virtual item.

In practical implementations, the call of the call object may be implemented by meeting at least one of the example call conditions. For example, all the example call conditions are met, or only one or two of the example call conditions are met, which is not limited in the embodiments of the disclosure.

In some embodiments, after presenting a target virtual object and a call object in a first form, the terminal controls the call object to move with the target virtual object by: obtaining a relative distance between the target virtual object and the call object; and controlling the call object in the first form to move to a first target position relative to the target virtual object in a case that the relative distance exceeds a first distance threshold.

Here, in practical applications, too long or too short relative distance between the call object and the target virtual object will be not conducive to the call object to assist the target virtual object. The first distance threshold is a maximum distance between the position of the call object and the target virtual object when the call object is convenient for assisting the target virtual object. When the relative distance between the call object and the target virtual object exceeds the first distance threshold, it is considered that the call object is too far away from the target virtual object. In this case, the call object is located in an area that is not convenient for assisting the target virtual object. At this time, the active following behavior of the call object may be triggered, that is, the call object is controlled to move to the position close to the target virtual object, and the call object is controlled to move to the first target position convenient for assisting the target virtual object. When the relative distance between the call object and the target virtual object is less than a target distance threshold (that is, a minimum distance between the position of the call object and the target virtual object when the call object is convenient for assisting the target virtual object, which is less than the first distance threshold), it is considered that the call object is too close to the target virtual object. At this time, the call object is also located in an area that is not convenient for assisting the target virtual object. In this case, the active following behavior of the call object may also be triggered, that is, the call object is controlled to move away from the position of the target virtual object, and the call object is controlled to move to the first target position convenient for assisting the target virtual object. When the relative distance between the call object and the target virtual object is greater than the target distance threshold and less than the first distance threshold, it is considered that the call object is located in an area convenient for assisting the target virtual object, and the call object may be controlled to stay in situ. However, in practical applications, in order to ensure that the call object is located in an exact position most convenient for assisting the target virtual object, the call object may be controlled to move to the first target position most convenient for assisting the target virtual object.

The first target position is an ideal position of the call object relative to the target virtual object, and is a position most conducive to the call object to assist the target virtual object. The first target position is related to the attributes, interaction habits and the like of the call object and the target virtual object. First target positions corresponding to different call objects and different target virtual objects may be different. For example, the first target position may be a position located at the right rear of the target virtual object with a certain distance, a position located at the left rear of the target virtual object with a certain distance, or any position in a sector area with a preset angle centered on the target virtual object. The first target position is not limited in the disclosure, and is determined according to actual situations in practical applications.

In some embodiments, after presenting a target virtual object and a call object in a first form in a virtual scene, the terminal may further control the call object to move with the target virtual object by: controlling the target virtual object to move in the virtual scene; and presenting a second target position of the call object in the first form relative to the target virtual object in a tracking area centered on a position of the target virtual object with the movement of the target virtual object, and controlling the call object in the first form to move to the second target position.

In some embodiments, in the process of controlling the call object in the first form to move to the second target position, in a case that an obstacle exists in a moving route of the call object or the moving route includes different geographical environments that make the call object unable to reach the second target position, the call object is controlled to move to a third target position, where the orientations of the third target position and the second target position relative to the target virtual object are different.

In practical applications, in a case that an obstacle exists in the moving route of the call object, an unreachable reminder may also be presented.

In some embodiments, before controlling a call object to move to a third target position, the terminal may further determine the third target position by: determining at least two positions through which the call object moves from the current position to a second target position in a tracking area, and selecting a position with a distance to the second target position less than a target distance from the at least two positions as the third target position; or expanding the tracking area in a case that no reachable position exists in the tracking area, and determining the third target position relative to a target virtual object in the expanded tracking area.

Here, in the process of controlling the call object to move to the second target position (such as a position at the right rear of a player with a certain distance) most conducive to assisting the target virtual object, when the call object may not be controlled to reach the second target position, the call object may be controlled to move to other positions. For example, the call object may be controlled to reach a reachable point closest to the right rear of the target virtual object or to reach a position at the left rear of the target virtual object with a certain distance; or the tracking area may be expanded, and an appropriate reachable target point may be found according to the above mode in the expanded tracking area, so as to control the call object to move to the found appropriate reachable target point.

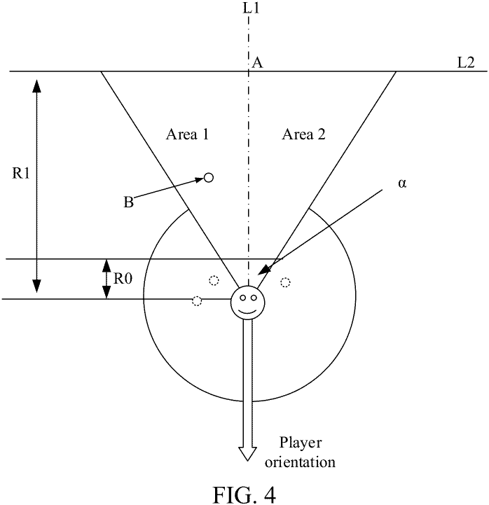

FIG. 4 is a schematic diagram of following of a call object according to some embodiments. A reverse extension line L1 of a target virtual object (player) in a forward direction is extended leftward and rightward to form two included angle areas, included angles α may be configured, a point A with a distance R1 between the position of the player and the reverse extension line L1 is obtained, and a vertical line L2 passing through the point A and perpendicular to the reverse extension line L1 is drawn. In this way, the reverse extension line L1, the vertical line L2 and included angle half-lines form left and right triangular tracking areas (area 1 and area 2) or form left and right sector tracking areas. A target point (point B) that the call object may reach is selected preferentially in the tracking area most conducive to assisting the target virtual object, such as the area 1 at the right rear of the player, as a target point of the call object following the target virtual object (that is, a third target position). If there is no appropriate target point in the area 1 at the right rear, the second way is to find an appropriate target point in the area 2 at the left rear of the player. If an appropriate target point is not found in the area 2 at the left rear of the player, a search area is expanded, and an appropriate target point is selected in the expanded search area in the above mode until an appropriate reachable target point (that is, another reachable position) is found as the third target position.

In some embodiments, after presenting a target virtual object and a call object in a first form in a virtual scene, the terminal may further control the call object to move with the target virtual object by: controlling the target virtual object to move in the virtual scene; presenting moving route indication information with the movement, the moving route indication information being used for indicating a moving route of the call object moving with the target virtual object; and controlling the call object to move according to the moving route indicated by the moving route indication information.

Here, if the call object is already located in a relative position most conducive to assisting the target virtual object before the terminal controls the target virtual object to move in the virtual scene, in the process of controlling the target virtual object to move in the virtual scene, the moving route indicated by the moving route indication information is a moving route of the target virtual object, and the terminal controls the call object to move synchronously with the target call object according to the moving route indicated by the moving route indication information, so as to ensure that the call object is always located in the relative position most conducive to assisting the target virtual object. If the call object is not located in a relative position most conducive to assisting the target virtual object before the terminal controls the target virtual object to move in the virtual scene, in the process of controlling the target virtual object to move in the virtual scene, the moving route indicated by the moving route indication information is a moving route for real-time adjustment of the call object, the terminal controls the call object to move according to the moving route indicated by the moving route indication information, and the relative position of the call object relative to the target virtual object may be adjusted in real time, so as to ensure that the call object is located in the relative position most conducive to assisting the target virtual object as much as possible.

Operation 102: Control the form of the call object to be transformed from the first form to a second form in a case that the target virtual object is in an interactive preparation state for interacting with other virtual objects in the virtual scene, and control the call object in the second form to be in an interactive auxiliary state to assist the target virtual object to interact with the other virtual objects.

The call object may have at least two different working states, such as a non-interactive preparation state and an interactive preparation state. When the call object meets a working state transformation condition, the terminal may control the call object to transform the working state, where the working state transformation condition of the call object may be related to the working state of the target virtual object. For example, assuming that the call object is in a following state of following the target virtual object to move by default, when the target virtual object is in a non-interactive preparation state for interacting with the other virtual objects in the virtual scene, it is determined that the call object does not meet a working state condition, and thus, the call object is controlled to be maintained in the following state; and when the target virtual object is in an interactive preparation state for interacting with the other virtual objects in the virtual scene, it is determined that the call object meets a working state transformation condition, and thus, the call object is controlled to be transformed from the following state to the interactive preparation state.

In some embodiments, the terminal may control the form of the call object to be transformed from the first form to a second form by: controlling the call object in the first form to move to a target position with a distance to the target virtual object as a target distance; and controlling the call object to be transformed from the first form to the second form in the target position.

In practical applications, the call object has at least two different forms. When a form transformation condition (related to the working state of the target virtual object) is met, the call object may be controlled to transform the form. For example, when the call object is a cartoon character and the working state of the target virtual object in the virtual scene is a non-interactive preparation state, it is determined that the call object does not meet a form transformation condition, and thus, the form of the call object is controlled to be a character form (that is, a first form); and when the target virtual object is transformed from a non-interactive preparation state to an interactive preparation state, for example, when the target virtual object is in a state of shoulder aiming or sight aiming, it is determined that the call object meets a form transformation condition, the call object in a character form is controlled to move to a target position, and the call object is controlled to be transformed from the character form to a second form such as a virtual shield wall or a shield in the target position.

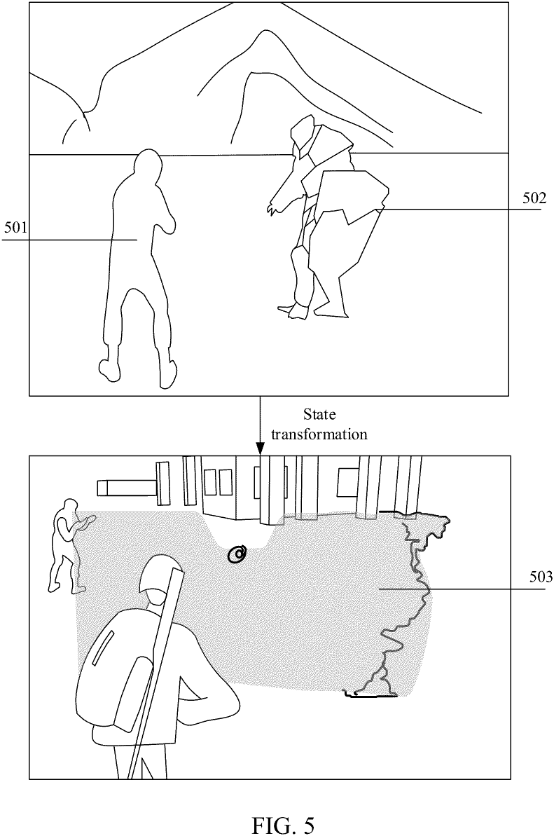

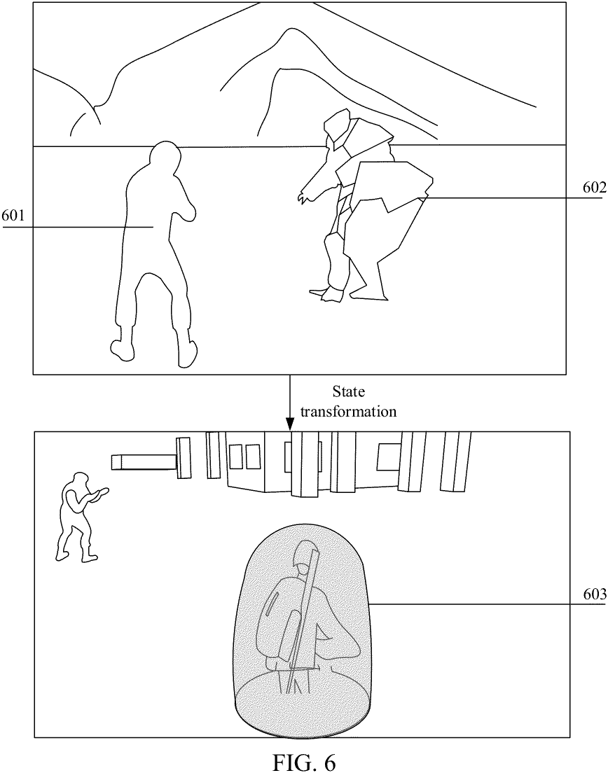

FIG. 5 and FIG. 6 are schematic diagrams of state transformation of a call object according to some embodiments. In FIG. 5, when a target virtual object 501 is in a non-interactive preparation state in a virtual scene, the form of the call object is a character form 502 (that is, a first form); and when the target virtual object 501 is in an interactive preparation state of shoulder aiming or sight aiming, the call object in the character form is controlled to move to a target position, and the call object is controlled to be transformed from the character form (that is, the first form) to a virtual shield wall form 503 (that is, a second form) in the target position. In FIG. 6, when a target virtual object 601 is in a non-interactive preparation state in a virtual scene, the form of the call object is a character form 602 (that is, a first form); and when the target virtual object 601 is in an interactive preparation state of shoulder aiming or sight aiming, the call object with a cartoon character image is controlled to move to a target position, and the call object is controlled to be transformed from the character form (that is, the first form) to a shield form 603 (that is, a second form) in the target position.

In some embodiments, the terminal may further display an interaction picture corresponding to interaction between the target virtual object and the other virtual objects, the target virtual object and the other virtual objects being located on both sides of the call object; and control the call object to block the interactive operation in a case that the other virtual objects perform an interactive operation for the target virtual object through virtual props in the process of displaying the interaction picture.

Here, the call object in the second form may block the attack of the other virtual objects on the target virtual object. For example, when the call object in the second form is a virtual shield wall and the other virtual objects fire bullets to attack the target virtual object, if the bullets act on the virtual shield wall, the virtual shield wall may block the attack of the bullets on the target virtual object to achieve the function of protecting the target virtual object.

In some embodiments, the terminal may further present attribute transformation indication information corresponding to the call object, where the attribute transformation indication information is used for indicating an attribute value of the call object deducted by blocking the interactive operation; and control the form of the call object to be transformed from the second form to the first form in a case that the attribute transformation indication information indicates that the attribute value of the call object is less than an attribute threshold.

The attribute value may include at least one of the following: a hit point, a life bar, an energy value, a health point, an ammunition, and a defense. In order to ensure the balance of the game, although the call object is able to block the attack from the front, own attributes will also be lost due to the attack, and own attribute values will be reduced. When the attribute value is less than an attribute threshold, the form of the call object is controlled to be transformed from the second form to the first form.

For example, when the call object is shield type AI, although a virtual shield wall may block the attack from the front, the call object will also continue to lose points (the life bar of the shield type AI) due to the attack, and when the life bar is less than a certain set value, the call object will exit from the shield wall state and enter a character stricken action.

In some embodiments, when the target virtual object and the other virtual objects are located on both sides of the call object, the terminal may further display a picture of the target virtual object observing the other virtual objects through the call object in the second form, and highlight the other virtual objects in the picture.

The picture obtained by observing the other virtual objects through the call object in the second form may be displayed by means of night vision, and profiles of the other virtual objects may be highlighted in the picture to highlight the other virtual objects. For example, the call object in the second form is an opaque virtual shield wall (with a shielding effect), and the target virtual object and the other virtual objects are located on both sides of the virtual shield wall. Under normal conditions, when the target virtual object observes the virtual shield wall from the own view, the other virtual objects shielded by the virtual shield wall may not be observed. However, in the embodiments of the disclosure, when the target virtual object observes the virtual shield wall from the own view, since the other virtual objects shielded by the virtual shield wall are displayed by means of night vision or perspective, it may be determined that the other virtual objects are visible relative to the target virtual object, that is, the target virtual object is able to observe the other virtual objects shielded by the virtual shield wall. When the other virtual objects observe the virtual shield wall from the own view, the target virtual object shielded by the virtual shield wall may not be observed. In this way, the other virtual objects are exposed in the field of vision of the target virtual object, but the target virtual object is not exposed in the field of vision of the other virtual objects, which is conducive to controlling the target virtual object to formulate an interaction policy that is able to cause the maximum damage to the other virtual objects, and perform a corresponding interactive operation according to the interaction policy, thereby improving the interaction ability of the target virtual object to increase the human-computer interaction efficiency.

In some embodiments, when the target virtual object and the other virtual objects are located on both sides of the call object, in the process of interaction between the target virtual object and the other virtual objects, the target virtual object is controlled to project a virtual prop in the virtual scene; and when the virtual prop passes through the call object, effect enhancement prompt information is presented, where the effect enhancement prompt information is used for prompting that the action effect corresponding to the virtual prop is enhanced.

Projection may include throwing or launching. For example, the target virtual object is controlled to throw a first virtual prop (such as a dart, a grenade, or a javelin) in the virtual scene, or the target virtual object is controlled to launch a sub-virtual prop (correspondingly, such as a bullet, an arrow, or a bomb) through a second virtual prop (such as a gun, a bow, or a ballista) in the virtual scene. When the first virtual prop or the sub-virtual prop passes through the call object, gain effects, such as attack enhancement, may be obtained.

In some embodiments, after controlling the form of the call object to be transformed from the first form to a second form and controlling the call object in the second form to be switched from a following state to an interactive auxiliary state, the terminal may further control the target virtual object to move in the virtual scene in the process of maintaining the target virtual object in the interactive preparation state; and control the call object in the second form to move with the target virtual object in the process of controlling the target virtual object to move.

For example, when the call object in the second form is a virtual shield wall, if the target virtual object moves or turns in an aiming state, the virtual shield wall is controlled to follow the target virtual object to move or turn in real time, so as to ensure that the virtual shield wall is always located in front of the target virtual object and may be suspended; and when the call object in the second form is a shield, if the target virtual object moves or turns in an aiming state, the shield is controlled to follow the target virtual object to move or turn in real time, so as to ensure that the shield is always located around the target virtual object.

In some embodiments, the terminal automatically adjusts the moving route of the call object to avoid the obstacle in a case that the call object moves to a blocking area with an obstacle in the process of controlling the call object in the second form to move with the target virtual object.

In practical applications, the terminal may continuously detect the position coordinates of the call object relative to the target virtual object in the process of controlling the call object in the second form to move with the target virtual object. With the moving or turning of the target virtual object, the position coordinates will be continuously corrected, and the call object will also be overlapped with the position coordinates. When there is an obstacle at the position coordinates, the call object is prevented from moving to the coordinate position, and the call object is controlled to move to a reachable position closest to the position coordinates. In the process of controlling the call object to move, the moving speed of the call object is configurable.

When the target virtual object moves or turns in an interactive preparation state, the call object will move or turn in real time following the interactive preparation state, so as to ensure that the call object is always located in a position that is able to assist the target virtual object. For example, when the call object in the second state is a virtual shield wall, it is ensured that the virtual shield wall is located in front of the target virtual object. For another example, when the call object in the second state is a shield, it is ensured that the shield is located around the target virtual object.

In some embodiments, after controlling the call object in the second form to be switched from the following state to the interactive auxiliary state, the terminal may further control the form of the call object to be transformed from the second form to the first form, and control a working state of the call object in the first form to be switched from the interactive auxiliary state to the following state in a case that the target virtual object exits the interactive preparation state.

For example, when the call object is shield type AI, the corresponding first form is a character form, and the corresponding second form is a virtual shield wall. When the target virtual object exits the interactive preparation state, the form of the call object will be immediately transformed from the virtual shield wall to the character form, and the call object returns to a default position of following the target virtual object, such as a target position at the right rear of the target virtual object, and is switched from an interactive auxiliary state to a following state. In this way, the form and working state of the call object are adapted to the working state of the target virtual object, so that the call object may play an auxiliary role against the target virtual object in time. By means of skills of the call object, skills of the target virtual object are able to improve, thereby improving the interaction ability of the target virtual object to increase the human-computer interaction efficiency.

In some embodiments, the terminal may control the form of the call object to be transformed from the first form to a second form, and control the call object in the second form to be in an interactive auxiliary state by: controlling the target virtual object to aim at a target position in the virtual scene by a target virtual prop, and presenting a corresponding sight pattern in the target position; and controlling the call object to move to the target position, transforming the first form to a second form in the target position, and controlling the call object in the second form to be in an interactive auxiliary state in response to a transformation instruction triggered based on the sight pattern.

A locked target corresponding to the target position may be another virtual object different from the target virtual object in the virtual scene, or may be a scene position in the virtual scene, such as the hillside, sky, tree, or the like in the virtual scene. In practical applications, a target virtual prop may be provided with a corresponding sight pattern (such as a sight pattern of a virtual shooting gun), so that the sight pattern is presented in the target position after aiming at the target position. According to different locked targets corresponding to the target position, the interactive auxiliary states corresponding to the call object may be different. For example, when the terminal controls the target virtual object to aim at the target object in the virtual scene by a target virtual prop (that is, the locked target is another virtual object), the terminal controls the call object in the first form to be in an auxiliary attack state, that is, controls the call object in the auxiliary attack state to attack the target object by a corresponding specific skill. When the terminal controls the target virtual object to aim at the target position in the virtual scene by a target virtual prop (there is no target object, for example, the locked target is a point on the ground, a point in the sky or another scene position in the virtual scene), the terminal controls the call object in the first form to move to the target position, and controls the call object to be transformed from the first form to a second form in the target position. For example, the terminal controls the call object to be transformed from a character form to a shield form, and controls the call object in the shield form to be switched from a following state (corresponding to the first form (such as a character state)) to an auxiliary protection state (corresponding to the shield state), thereby controlling the call object to be in an interactive auxiliary state adapted to the locked target to assist the target virtual object to interact in the virtual scene.

In some embodiments, after controlling the form of the call object to be transformed from the first form to a second form and controlling the call object in the second form to be in an interactive auxiliary state, the terminal may further present a recall control for recalling the call object; and control the call object to move from the target position to an initial position, and control the form of the call object to be transformed from the second form to the first form in response to a trigger operation for the recall control.

Here, the recall of the call object is implemented by the recall control. When the call object is recalled, no matter what form the call object is in before the recall, the call object which is recalled may be controlled to be in the first form (that is, the initial form).

The following takes a virtual scene which is a virtual shooting scene as an example to continue to describe the method for controlling a call object in a virtual scene provided in the embodiment of the disclosure. FIG. 3B is a schematic flow diagram of a method for controlling a call object in a virtual scene according to some embodiments. The method includes the following operations:

Operation 701: Present, by a terminal, a target virtual object holding a shooting prop and a call object in a character form in a virtual shooting scene.

Here, while presenting the target virtual object holding a shooting prop, the terminal further presents the call object corresponding to the target virtual object. At this time, the call object is in a character form (that is, the above first form). Here, the call object is an image in a character form for assisting the target virtual object to interact with the other virtual objects in the virtual scene, and the image may be a virtual character, a cartoon character, or the like. The call object may be a call object randomly allocated to the target virtual object by a system when a user first enters the virtual scene, a call object called by the user according to scene guide information in the virtual scene by controlling the target virtual object to perform some specific tasks to reach call conditions of the call object, or a call object called by the user by triggering a call control. For example, in a case that call conditions are met, the call control is tapped to call the above call object.

Operation 702: Control the target virtual object to aim at a target position by the shooting prop in the virtual shooting scene, and present a corresponding sight pattern in the target position.

Here, after presenting the target virtual object holding a shooting prop and the call object corresponding to the target virtual object, the terminal may control the target virtual object to aim at the target position in the virtual scene by the shooting prop for interaction. A locked target corresponding to the target position may be another virtual object different from the target virtual object in the virtual scene, or may be a scene position in the virtual scene, such as the hillside, sky, tree, or the like in the virtual scene. In practical applications, the shooting prop may be provided with a corresponding sight pattern (such as a sight pattern of a virtual shooting gun), so that the sight pattern is presented in the target position after aiming at the target position.

Operation 703: Control the call object to move to the target position, and transform the character form to a shield state in the target position to assist the target virtual object to interact with the other virtual objects in response to a transformation instruction triggered based on the sight pattern.

In practical applications, for different locked targets, in some embodiments, different interactive auxiliary states, such as an auxiliary protection state and an auxiliary attack state, may be set for the call object. When the locked target is another virtual object, the call object is controlled to be in an auxiliary attack state, and the call object in the auxiliary attack state may be controlled to attack the other virtual objects in the virtual shooting scene. When the locked target is a scene position, for example, when the locked target is a point on the ground, a point in the sky or another scene position in the virtual scene, the call object is controlled to move to the target position, and the call object is controlled to be transformed from the character form to a shield form in the target position. For example, the call object in a character state is controlled to be switched from a following state to an auxiliary protection state (corresponding to a shield state), and the call object in an auxiliary protection state is controlled to assist the target virtual object to interact with the other virtual objects in the virtual shooting scene. In the above way, the call object is controlled to be in an interactive auxiliary state adapted to the locked target to assist the target virtual object to interact with the other virtual objects. With the help of the call object, skills of the target virtual object are able to improve, thereby improving the interaction ability of the target virtual object to increase the human-computer interaction efficiency.

An example embodiment of an actual application scene is described below. Taking a virtual scene which is a shooting game and a call object which is shield type AI for assisting a target virtual object as an example, the first form of the shield type AI is a character form, and the second form of the shield type AI is a virtual shield wall (that is, the above shield state). When the target virtual object is in an aiming state (that is, the above interactive preparation state), the shield type AI is controlled to be automatically transformed from the character form to the virtual shield wall, so as to assist the target virtual object to interact with the other virtual objects in the virtual scene.

In some embodiments, the method for controlling a call object in a virtual scene may include the following processes: call of the shield type AI, logic of the shield type AI moving with the target virtual object, and state transformation of the shield type AI, which are described below one by one.

### 1. Call of Shield Type AI

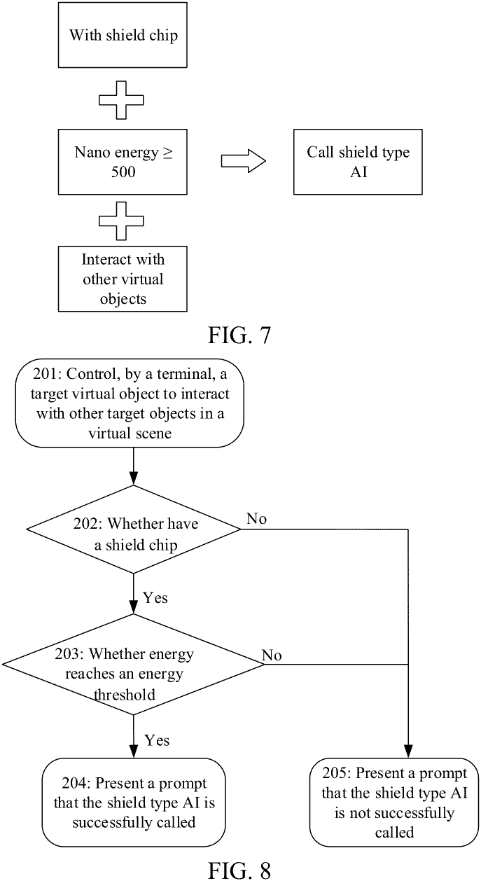

FIG. 7 is a schematic diagram of call conditions of a call object according to some embodiments. As shown in FIG. 7, the call conditions of the shield type AI are: the target virtual object has a shield item (or shield chip), the energy value of the target virtual object reaches an energy threshold, and the target virtual object interacts with the other virtual objects (such as any weak elite monster). When the above conditions are met, the shield type AI may be called.

FIG. 8 is a schematic diagram of a call method according to some embodiments. The method includes the following operations:

Operation 201: Control, by a terminal, a target virtual object to interact with other target objects in a virtual scene.

Operation 202: Judge whether the target virtual object has a shield chip.

Here, in practical implementations, when there is a shield item for calling shield type AI in the virtual scene, the terminal may control the target virtual object to pick up the shield item, and when the target virtual object successfully picks up the shield item, operation 203 is performed; and when there is no shield item for calling shield type AI in the virtual scene, or the target virtual object does not successfully pick up the shield item, operation 205 is performed.

Operation 203: Judge whether the energy of the target virtual object reaches an energy threshold.

Here, the energy of the target virtual object may be obtained through the interactive operation of the target virtual object in the virtual scene. The terminal obtains the energy value of the target virtual object. When the energy value of the target virtual object reaches the energy threshold (for example, the nano energy exceeds 500 points), operation 204 is performed; and when the energy value of the target virtual object does not reach the energy threshold (for example, the nano energy is less than 500 points), operation 205 is performed.

Operation 204: Present a prompt that the shield type AI is successfully called.

Here, when call conditions are met, the shield type AI may be called based on the shield item. The called shield type AI is in a character form (first form) by default, and is in a following state of following the target virtual object to move.

Operation 205: Present a prompt that the shield type AI is not successfully called.

### 2. Logic of Shield Type AI Moving With Target Virtual Object

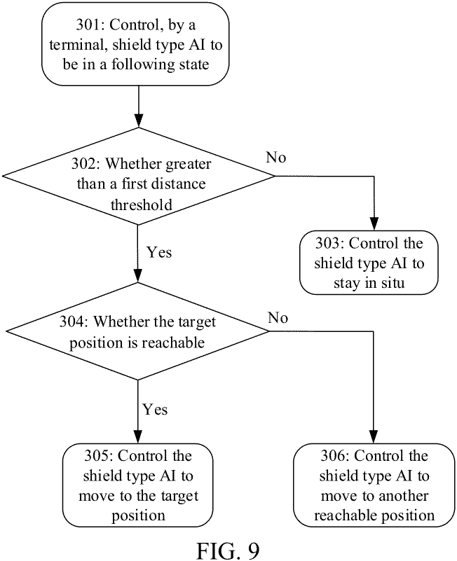

FIG. 9 is a schematic diagram of a following method of a call object according to some embodiments. The method includes the following operations:

Operation 301: Control, by a terminal, shield type AI to be in a following state.

Here, the newly called shield type AI is in a following state of following a target virtual object to move by default.

Operation 302: Judge whether a relative distance is greater than a first distance threshold.

Here, too long or too short relative distance between the call object and the target virtual object will be not conducive to the call object to assist the target virtual object. The first distance threshold is a maximum distance between the position of the call object and the target virtual object when the call object is convenient for assisting the target virtual object. In practical applications, a relative distance between the target virtual object and the shield type AI in a following state is obtained. When the relative distance is greater than the first distance threshold, it is considered that the shield type AI is too far away from the target call object and is located in an area that is not convenient for assisting the target virtual object, and at this time, operation 304 is performed. When the relative distance is less than the first distance threshold and greater than a target distance threshold (a minimum distance between the position of the call object and the target virtual object when the call object is convenient for assisting the target virtual object, which is less than the first distance threshold), it is considered that the shield type AI is located in an area that is convenient for assisting the target virtual object, and at this time, operation 303 is performed.

Operation 303: Control the shield type AI to stay in situ.

Operation 304: Judge whether the target position is reachable.

The target position (that is, the above first target position or second target position) is an ideal position of the shield type AI relative to the target virtual object, and is a position most conducive to the shield type AI to assist the target call object. For example, the target position is a position at the right rear of the target virtual object with a certain distance. When the target position is reachable, operation 305 is performed; and when the target position is unreachable, operation 306 is performed.

Operation 305: Control the shield type AI to move to the target position.

Operation 306: Control the shield type AI to move to another reachable position.

The another reachable position is the above third target position.

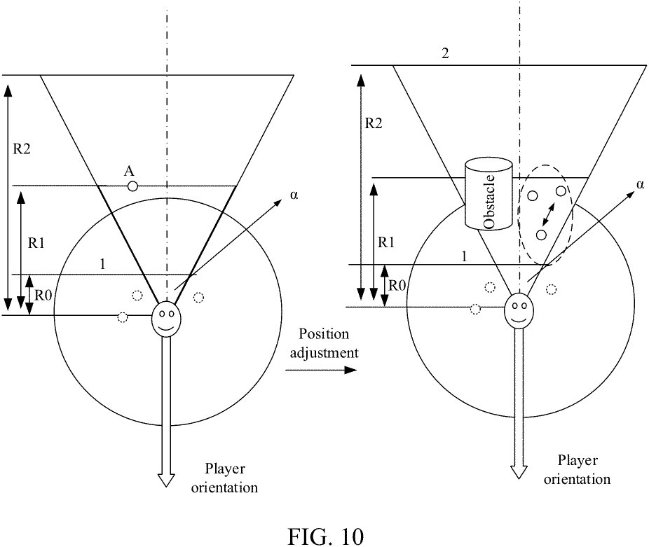

FIG. 10 is a schematic diagram of determination of a moving position according to some embodiments. A reverse extension line of a target virtual object (player) in a forward direction is extended leftward and rightward to form two included angle areas, and included angles α may be configured. A vertical line 1 of the reverse extension line facing the player is drawn when the distance of the extension line is R0. When the shield type AI is located in an area between the horizontal line of the target virtual object and the vertical line 1, it is considered that the shield type AI is too close to the target virtual object and is located in a position not conducive to assisting the target virtual object. At this time, the shield type AI is controlled to move to a position A at the right rear of the target virtual object with a certain distance, where the distance between the horizontal line of the position A and the horizontal line of the target virtual object is R1.

When the distance of the extension line is R2, a vertical line 2 of the extension line is drawn. When the distance between the horizontal line of the shield type AI and the horizontal line of the target virtual object is greater than R2, it is considered that the shield type AI is too far away from the target virtual object and is located in a position not conducive to assisting the target virtual object. At this time, the shield type AI is controlled to move to a position A at the right rear of the target virtual object with a certain distance, where the distance between the horizontal line of the position A and the horizontal line of the target virtual object is R1.

When there is an obstacle in the position A at the right rear of the target virtual object, that is, there is no appropriate target point in the triangular area at the right rear of the player, the second way is to find an appropriate target point in the triangular area at the left rear of the player. If an appropriate target point is not found in the triangular area at the left rear of the player, the R1 is expanded to the R2, and points are selected according to the above rules until an appropriate reachable target point (that is, another reachable position) is found.

### 3. State Transformation of Shield Type AI

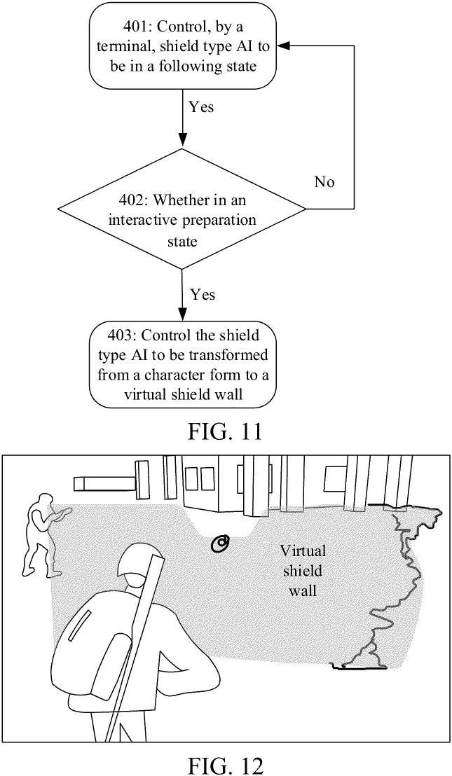

FIG. 11 is a schematic diagram of a state transformation method of a call object according to some embodiments. The method includes the following operations:

Operation 401: Control, by a terminal, shield type AI to be in a following state.

Operation 402: Judge whether a target virtual object is in an interactive preparation state.

Here, when the target virtual object is in a state of shoulder aiming or sight aiming, it is considered that the target virtual object is in an interactive preparation state, and at this time, operation 403 is performed; otherwise, operation 401 is performed.

Operation 403: Control the shield type AI to be transformed from a character form to a virtual shield wall.

FIG. 12 is a schematic diagram of state transformation of a call object according to some embodiments. Here, when the target virtual object is in a state of shoulder aiming or sight aiming, the shield type AI in a character form will quickly rush to a position with a target distance in front of the target virtual object, and is transformed from the character form to a virtual shield wall. The orientation of the virtual shield wall is consistent with the current orientation of the target virtual object. The default effect of the virtual shield wall is to block all remote attacks in front of the virtual shield wall in one direction.

In practical applications, after the shield type AI is transformed to the virtual shield wall, the terminal may continuously detect the position coordinates of the virtual shield wall relative to the target virtual object. With the moving or turning of the target virtual object, the position coordinates will be continuously corrected, the virtual shield wall will also be overlapped with the position coordinates, and a suspended position is ignored. If there is an obstacle at the position coordinates in front of the player, the virtual shield wall is prevented from moving to the coordinate position, and the virtual shield wall may only move to a reachable position closest to the position coordinates. The moving speed of the virtual shield wall is configurable.

When the target virtual object moves or turns in an interactive preparation state, the virtual shield wall will move or turn in real time following the interactive preparation state, so as to ensure that the virtual shield wall is always located in front of the target virtual object and may be suspended. However, if there is an obstacle in front of the target virtual object in the interactive preparation state, the target virtual object will be pushed away by the obstacle and will not be inserted. When the target virtual object exits the interactive preparation state, the form of the call object will be immediately transformed from the virtual shield wall to the character form, and the call object returns to a default position of following the target virtual object, that is, a target position at the right rear of the target virtual object.

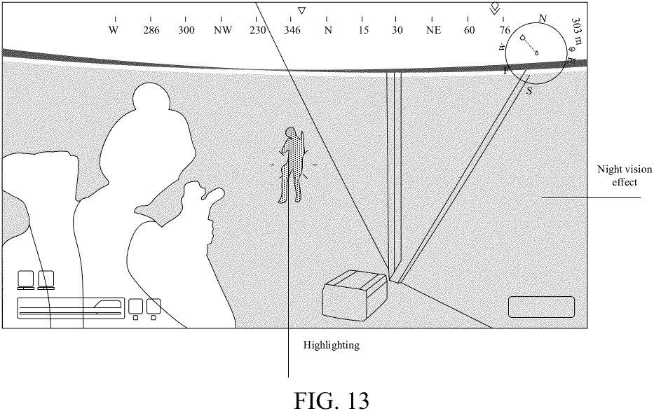

FIG. 13 is a schematic diagram of an action effect of a call object according to some embodiments. The target virtual object may interact with the virtual shield wall to obtain different combat gains. For example, the picture obtained by observing the other virtual objects through the virtual shield wall is displayed by means of night vision, and profiles of the other virtual objects are highlighted in the picture to highlight the other virtual objects. When the other virtual objects which are highlighted are removed from the area where the virtual shield wall is located in the field of vision of the target virtual object, the highlighting effect is canceled. For another example, when the bullets fired by the target virtual object pass through the virtual shield wall, gain effects, such as attack enhancement, may be obtained, and the visual effect of the target virtual object observing the other virtual objects on the other side through the virtual shield wall may be enhanced.

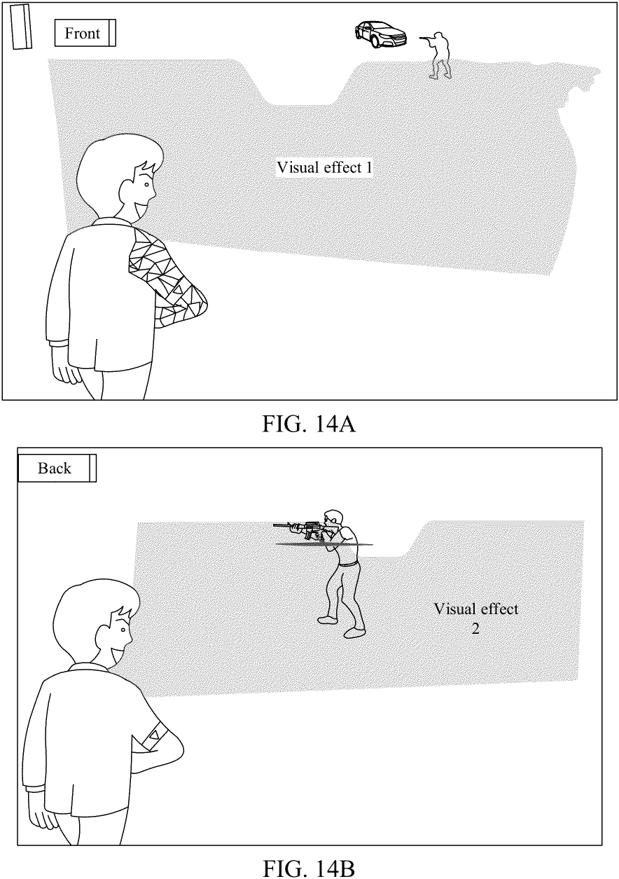

FIG. 14A and FIG. 14B are schematic diagrams of pictures observed through a call object according to some embodiments. Since the virtual shield wall is generated by a nano energy field, in order to distinguish the effects of both sides of the virtual shield wall on long-range flying objects such as bullets, when the target virtual object and the other virtual objects are located on both sides of the virtual shield wall, the visual effect 1 (FIG. 14A) observed through the virtual shield wall from the side of the target virtual object (front) is different from the visual effect 2 (FIG. 14B) observed through the virtual shield wall from the side of the other virtual objects (back).

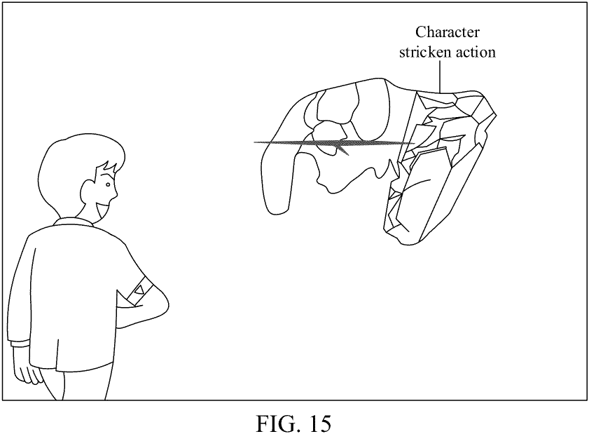

FIG. 15 is a schematic diagram of state transformation of a call object according to some embodiments. In order to ensure the balance, although the virtual shield wall may block the attack from the front, the call object will also continue to lose points (the life bar of the shield type AI) due to the attack, and when the life bar is less than a certain set value, the call object will exit from the shield wall state and enter a character stricken action.

In addition, in practical applications, the terminal may further control the shield type AI by a trigger operation for a locking control of the shield type AI. For example, when the terminal controls the target virtual object to aim at a target object in the virtual scene by a target virtual prop, the locking control is triggered, and in response to the trigger operation, the terminal controls the shield type AI to attack the target object by a specific skill. When the terminal controls the target virtual object to aim at a target position (there is no target object) in the virtual scene by a target virtual prop, the locking control is triggered, and in response to the trigger operation, the terminal controls the shield type AI to move to the target position, and controls the shield type AI to be transformed from a character form to a virtual shield wall in the target position, so as to block remote attacks in front of the virtual shield wall.

In the above way, the target virtual object does not need to make any instructions or operations to the shield type AI, and the shield type AI may monitor the behavior state of the target virtual object and automatically make decisions to perform the corresponding skills and behaviors. When the position of the target virtual object changes, the shield type AI will move with the target virtual object. In this way, the player may get automatic protection of the shield type AI without sending any instructions to the shield type AI, so that the player is able to focus on the unique character (that is, the target virtual object) controlled by the player to improve the operation efficiency.

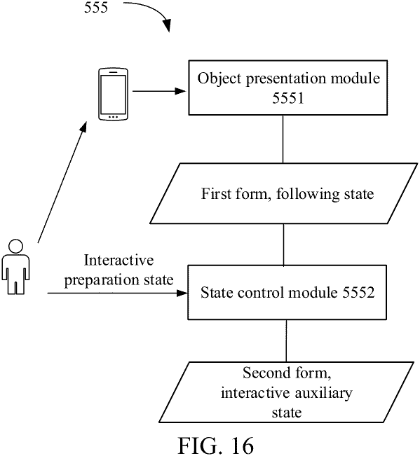

The following continues to describe an example structure of an apparatus 555 for controlling a call object in a virtual scene according to some embodiments implemented as a software module. FIG. 16 is a schematic structural diagram of an apparatus for controlling a call object in a virtual scene according to some embodiments. The software module stored in the apparatus 555 for controlling a call object in a virtual scene of the memory 550 in FIG. 2 may include:
an object presentation module 5551, configured to present a target virtual object and a call object in a first form in a virtual scene; and
a state control module 5552, configured to control the form of the call object to be transformed from the first form to a second form in a case that the target virtual object is in an interactive preparation state for interacting with other virtual objects in the virtual scene, and
control the call object in the second form to be in an interactive auxiliary state to assist the target virtual object to interact with the other virtual objects.

In the above solution, before the presenting a call object in a first form, the method further includes:
an object calling module, configured to control the target virtual object to pick up the virtual item in a case that a virtual item for calling the call object exists in the virtual scene;
obtain an energy value of the target virtual object; and
call the call object based on the virtual item in a case that the energy value of the target virtual object reaches an energy threshold.

In the above solution, after the presenting a target virtual object and a call object in a first form, the apparatus further includes:
a first control module, configured to obtain a relative distance between the target virtual object and the call object; and
control the call object in the first form to move to a first target position relative to the target virtual object in a case that the relative distance exceeds a first distance threshold.

In the above solution, after the presenting a target virtual object and a call object in a first form, the apparatus further includes:
a second control module, configured to control the target virtual object to move in the virtual scene; and
present a second target position of the call object in the first form relative to the target virtual object in a tracking area centered on a position of the target virtual object with the movement, and control the call object in the first form to move to the second target position.

In the above solution, the apparatus further includes:
a movement adjusting module, configured to control the call object to move to a third target position in a case that an obstacle exists in a moving route of the call object or the moving route includes different geographical environments that make the call object unable to reach the second target position in the process of controlling the call object in the first form to move to the second target position,
where the orientations of the third target position and the second target position relative to the target virtual object are different.

In the above solution, before the controlling the call object to move to a third target position, the apparatus further includes:
a position determining module, configured to determine at least two positions through which the call object moves from the current position to the second target position in the tracking area, and select a position with a distance to the second target position less than a target distance from the at least two positions as the third target position; or,
expand the tracking area in a case that no reachable position exists in the tracking area, and determine the third target position relative to the target virtual object in the expanded tracking area.

In the above solution, after the presenting a target virtual object and a call object in a first form, the apparatus further includes:
a third control module, configured to control the target virtual object to move in the virtual scene;
present moving route indication information with the movement, the moving route indication information being used for indicating a moving route of the call object moving with the target virtual object; and
control the call object to move according to the moving route indicated by the moving route indication information.

In the above solution, the state control module is configured to control the call object in the first form to move to a target position with a distance to the target virtual object as a target distance; and

control the call object to be transformed from the first form to the second form in the target position.

In the above solution, the apparatus further includes:
a fourth control module, configured to display an interaction picture corresponding to interaction between the target virtual object and the other virtual objects, the target virtual object and the other virtual objects being located on both sides of the call object; and
control the call object to block the interactive operation in a case that the other virtual objects perform an interactive operation for the target virtual object through virtual props in the process of displaying the interaction picture.

In the above solution, the apparatus further includes:
a fifth control module, configured to present attribute transformation indication information corresponding to the call object,
where the attribute transformation indication information is used for indicating an attribute value of the call object deducted by blocking the interactive operation; and
control the form of the call object to be transformed from the second form to the first form in a case that the attribute transformation indication information indicates that the attribute value of the call object is less than an attribute threshold.

In the above solution, the apparatus further includes:

a highlighting module, configured to display a picture of the target virtual object observing the other virtual objects through the call object in the second form in a case that the target virtual object and the other virtual objects are located on both sides of the call object, and highlight the other virtual objects in the picture.

In the above solution, the apparatus further includes:
an enhancement prompt module, configured to control the target virtual object to project a virtual prop in the virtual scene in the process of interaction between the target virtual object and the other virtual objects in a case that the target virtual object and the other virtual objects are located on both sides of the call object; and
present effect enhancement prompt information in a case that the virtual prop passes through the call object, the effect enhancement prompt information being used for prompting that the action effect corresponding to the virtual prop is enhanced.

In the above solution, after the controlling the form of the call object to be transformed from the first form to a second form and controlling the call object in the second form to be switched from the following state to an interactive auxiliary state, the apparatus further includes:
a sixth control module, configured to control the target virtual object to move in the virtual scene in the process of maintaining the target virtual object in the interactive preparation state; and
control the call object in the second form to move with the target virtual object in the process of controlling the target virtual object to move.

In the above solution, the apparatus further includes:

a movement adjusting module, configured to automatically adjust the moving route of the call object to avoid the obstacle in a case that the call object moves to a blocking area with an obstacle in the process of controlling the call object in the second form to move with the target virtual object.

In the above solution, after the controlling the call object in the second form to be switched from the following state to an interactive auxiliary state, the apparatus further includes:

a seventh control module, configured to control the form of the call object to be transformed from the second form to the first form, and control a working state of the call object in the first form to be switched from the interactive auxiliary state to a following state in a case that the target virtual object exits the interactive preparation state.

In the above solution, the state control module is further configured to control the target virtual object to aim at a target position in the virtual scene by a target virtual prop, and present a corresponding sight pattern in the target position; and

control the call object to move to the target position, transform the first form to a second form in the target position, and control the call object in the second form to be in an interactive auxiliary state in response to a transformation instruction triggered based on the sight pattern.

In the above solution, the apparatus further includes:
an object recall module, configured to present a recall control for recalling the call object; and
control the call object to move from the target position to an initial position, and control the form of the call object to be transformed from the second form to the first form in response to a trigger operation for the recall control.

In some embodiments, an apparatus for controlling a call object in a virtual scene, including:
a first presentation module, configured to present a target virtual object holding a shooting prop and a call object in a character form in a virtual shooting scene;
an aiming control module, configured to control the target virtual object to aim at a target position by the shooting prop in the virtual shooting scene, and present a corresponding sight pattern in the target position; and
a state transformation module, configured to control the call object to move to the target position, and transform the character form to a shield state in the target position to assist the target virtual object to interact with the other virtual objects in response to a transformation instruction triggered based on the sight pattern.

A person skilled in the art would understand that these “modules” could be implemented by hardware logic, a processor or processors executing computer software code, or a combination of both.

Some embodiments provide a computer program product or a computer program. The computer program product or the computer program includes computer instructions, and the computer instructions are stored in a computer-readable storage medium. A processor of a computer device reads the computer instructions from the computer-readable storage medium, and the processor executes the computer instructions, so that the computer device performs the above method for controlling a call object in a virtual scene in the embodiment of the disclosure.

Some embodiments provide a computer-readable storage medium storing executable instructions. When the executable instructions are executed by a processor, the processor will perform the method for controlling a call object in a virtual scene provided in the embodiment of the disclosure.

In some embodiments, the computer-readable storage medium may be a memory such as an FRAM, a ROM, a PROM, an EPROM, an EEPROM, a flash memory, a magnetic surface memory, a compact disc, or a CD-ROM; or may be various devices including one of or any combination of the foregoing memories.

In some embodiments, the executable instructions may be written in the form of programs, software, software modules, scripts or codes in any form of programming languages (including compiled or interpreted languages, or declarative or procedural languages), and may be deployed in any form, including being deployed as stand-alone programs, or deployed as modules, components, sub-routines or other units suitable for use in computing environments.

As an example, the executable instructions may, but not necessarily, correspond to files in a file system, and may be stored in part of files for storing other programs or data, for example, stored in one or more scripts in hyper text markup language (HTML) documents, stored in a single file dedicated to the program in question, or stored in multiple collaborative files (such as files for storing one or more modules, sub-programs, or codes).

As an example, the executable instructions may be deployed to be executed on a computing device, or executed on multiple computing devices at the same location, or executed on multiple computing devices which are distributed in multiple locations and interconnected by means of a communication network.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure.

What is claimed is:

1. A method for controlling a call object in a virtual scene, performed by an electronic device, comprising:
presenting a target virtual object and the call object in a first form in the virtual scene;
controlling the call object to transform from the first form to a second form based on the target virtual object being in an interactive preparation state, the interactive preparation state being a state for interacting with another virtual object in the virtual scene; and controlling the call object in the second form to assist the target virtual object to interact with the other virtual objects.

2. The method according to claim 1, wherein before the presenting the call object in the first form, the method further comprises:
controlling the target virtual object to pick up a virtual item for calling the call object based on the virtual item in the virtual scene;
obtaining an energy value of the target virtual object; and
calling the call object with the virtual item based on the energy value of the target virtual object reaching an energy threshold.

3. The method according to claim 1, wherein after the presenting the target virtual object and the call object in the first form in the virtual scene, the method further comprises:
obtaining a relative distance between the target virtual object and the call object; and
controlling the call object in the first form to move closer to the target virtual object based on the relative distance exceeding a first distance threshold.

4. The method according to claim 1, wherein after the presenting the target virtual object and the call object in the first form in the virtual scene, the method further comprises:
controlling the target virtual object to follow the target virtual object in the virtual scene.

5. The method according to claim 1, wherein after the presenting, the method further comprises:
controlling the target virtual object to move in the virtual scene;
presenting moving route indication information during movement of the target virtual object, the moving route indication information indicating a moving route for the call object to move along; and
controlling the call object to move according to the moving route.

6. The method according to claim 1, wherein the controlling the call object to transform from the first form to the second form comprises:
controlling the call object in the first form to move to a target position at a target distance from the target virtual object; and
controlling the call object to transform from the first form to the second form in the target position.

7. The method according to claim 1, wherein the method further comprises:
blocking an interactive operation originated from the another virtual object from reaching the target virtual object when the target virtual object and the another virtual object are located on different sides of the call object in the second form and the interactive operation goes through the call object.

8. The method according to claim 7, wherein the method further comprises:
deducting an attribute value of the call object when the call object blocks the interactive operation, and
controlling the call object to transform from the second form to the first form based on a determination that the attribute value of the call object is less than an attribute threshold.

9. The method according to claim 1, wherein the method further comprises:
highlighting the another virtual object when the another virtual object is observed by the target virtual object through the call object in the second form.

10. The method according to claim 1, wherein the method further comprises:
enhancing an interactive operation originated from the target virtual object toward the another virtual object when the target virtual object and the another virtual object are located on different sides of the call object in the second form and the interactive operation goes through the call object.

11. The method according to claim 1, wherein the method further comprises:
controlling the target virtual object to move in the virtual scene while maintaining the target virtual object in the interactive preparation state; and
controlling the call object in the second form to move with the target virtual object while the target virtual object moves.

12. The method according to claim 1, further comprises:
in response to the target virtual object exits the interactive preparation state, controlling the call object to transform from the second form to the first form.

13. The method according to claim 6, wherein the target position is in an aiming direction of the target virtual object.

14. An apparatus for controlling a call object in a virtual scene, the apparatus comprising:
at least one memory configured to store program code; and
at least one processor configured to read the program code and operate as instructed by the program code, the program code comprising:
object presentation code configured to cause the at least one processor to present a target virtual object and the call object in a first form in the virtual scene; and
state control code configured to cause the at least one processor to control the call object to transform from the first form to a second form based on the target virtual object being in an interactive preparation state, the interactive preparation state being a state for interacting with another virtual objects in the virtual scene, and control the call object in the second form to assist the target virtual object to interact with the other virtual objects.

15. The apparatus according to claim 14, wherein the program code further comprises object calling code; and
wherein, before the object presentation code causes the at least one processor to present the call object in the first form, the object calling code is configured to cause the at least one processor to:
control the target virtual object to pick up a virtual item for calling the call object based on the virtual item in the virtual scene;
obtain an energy value of the target virtual object; and
call the call object with the virtual item based on the energy value of the target virtual object reaching an energy threshold.

16. The apparatus according to claim 14, wherein the program code further comprises first control code; and
wherein, after the object presentation code causes the at least one processor to present the call object in the first form, the first control code is configured to cause the at least one processor to:
obtain a relative distance between the target virtual object and the call object; and
control the call object in the first form to move closer to the target virtual object based on the relative distance exceeding a first distance threshold.

17. The apparatus according to claim 14, wherein the program code further comprises second control code; and
wherein, after the object presentation code causes the at least one processor to present the target virtual object and the call object in the first form, the second control code is configured to cause the at least one processor to:
control the target virtual object to follow the target virtual object in the virtual scene.

18. The apparatus according to claim 14, wherein the program code further comprises third control code; and
wherein, after the object presentation code causes the at least one processor to present the target virtual object and the call object in the first form, the third control code is configured to cause the at least one processor to:
control the target virtual object to move in the virtual scene;
present moving route indication information during movement of the target virtual object, the moving route indication information indicating a moving route for the call object to move along; and
control the call object to move according to the moving route.

19. The apparatus according to claim 14, wherein the state control code is further configured to cause the at least one processor to:
control the call object in the first form to move to a target position at a target distance from the target virtual object; and
control the call object to transform from the first form to the second form in the target position.

20. A non-transitory computer-readable storage medium storing computer code that when executed by at least one processor causes the at least one processor to:
present a target virtual object and a call object in a first form in a virtual scene; and
control the call object to transform from the first form to a second form based on the target virtual object being in an interactive preparation state, the interactive preparation state being a state for interacting with another virtual object in the virtual scene, and control the call object in the second form to assist the target virtual object to interact with the other virtual objects.
